(19) United States
(12) Patent Application Publication
(10) Pub. No.: US 2005/0102502 A1
(43) Pub. Date: May 12, 2005

(54) Method and system for identification

(76) Inventor: Hallgrim Sagen, Oslo (NO)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/949,035

(22) Filed: Sep. 24, 2004

(30) Foreign Application Priority Data
Sep. 26, 2003 (NO) 20034321

(51) Int. Cl. H04L 9/00; H04M 3/42

(52) U.S. Cl. 713/156; 713/186; 379/202.01

(57) ABSTRACT

The present invention relates to conferencing and data recording, in particular to providing secured and verified transactions by means of biometrics. The uniqueness of biometrics is combined with the robustness and reliability of PKI for use in conference applications. The invention is about identifying an individual from a biometric pattern, like the iris of the individual's eye, by means of an iris recognition system. The recognition system then provides the identity of the individual, which is further used to provide secure and reliable digital actions or verifications like authentication, signing and encryption.

### RELATED APPLICATION

This application claims priority under 35 U.S.C. § 119 or 365 to Norwegian Application No. 20034321, filed Sep. 26, 2003. The entire teachings of the above application are incorporated herein by reference.

### BACKGROUND OF THE INVENTION

Video conferencing systems are now widely being used as substitutes for personal communication and meetings. Consequently, more information that previously was preserved for closed rooms are now exchanged between remote sites. This introduces greater challenges related to security and personal identification. However, when more meetings and conversations are captured and presented as multimedia data streams like in videoconferencing, this opens up the possibilities for also documenting oral communication and verbal agreements.

If such documentation is to be legally valid, however, there has to be a trusted authentication system connected to the meetings. The most commonly used trusted system in digital communication is the PKI (Private Key Infrastructure) system. PKI is a digital security infrastructure used for electronic authentication, signing and encryption. It is based on the use of a key pair and a digital certificate issued by an authorized and trusted issuer.

By comparison, a conventional non-digital certificate is known as a public document to proof an identity or capacity. A trusted third party issues a certificate by a stamp and/or a sign. The reader of a certificate must be sure of the authenticity and validity of the certificate. The owner of the certificate must be put in relation to the certificate by something recognizable, like a picture and/or a sign of the owner.

A Digital Certificate (DC) principally corresponds to a conventional certificate. However, it is adjusted for use in electronic/digital media. A DC includes information like name of the owner and issuer, validation dates and a public key identifying the owner. Generally, a public key always has a corresponding private key, which is only known to the user. Data encrypted by a public key is only decryptable by the corresponding private key and vice versa. Consequently, data encrypted by a private key implies zero confidentiality, but full authenticity, whereas data encrypted by a public key implies zero authenticity, but full confidentiality.

The issuers of DCs should be organizations of high confidence, and are often related to an authority. In Norway, the most trusted issuer is ZebSign, an enterprise owned by Telenor and Norway Post. In other countries, telecommunication operators may act as issuers. Most of the different issuers have agreed to accept each other's certificates. This makes a certificate issued by ZebSign valid also in e.g. France, where France Telecom is the main issuer. This is called cross-certification, and allows for a global authorization system. The cross-certification assumes that the different issuers use the same certificate standard. The most common certificate standard is X.509 from IETF. Most of the certificates based on X.509 are approved as so-called Qualified Certificates, whose corresponding digital signatures are considered to satisfy the requirements for having the same legal effect as hand-written signatures.

Authentication related to data communication conventionally means to verify the correctness of a claimed identification. In connection with PKI, authentication is used to verify true registered users that are established with own DCs. The authentication process conventionally starts by entering a personal code or other data uniquely connecting the person to his/her associated certificate. The certificate is then captured from a SmartCard, a PC or a secure database and provided to the receiver. The receiver decrypts the certificate by the public key of the issuer, so disclosing information authenticating the sender. The DC is encrypted by the issuer's private key, so that a successful decryption of the certificate by the corresponding public key will also prove the authenticity of the certificate. Further, as the certificate includes the public key of the sender, the receiver will be able to decrypt any data signed by the sender with his/her private key.

As can be seen from the discussion above, secure transactions, authentication and digital signing is already a well-known and established technology in data communications. However, it is not adjusted to conferencing environments. A signer or a user to be authenticated needs to have some kind of personal communication equipment like a PC, a cellular phone or a SmartCard reader to identify himself and to capture the required DC and private key. This is usually not convenient in conference situations, where a number of users may share the same end-point located in some distance from the users. In addition, capturing the required DC and private key usually involves entering a personal code or password, which then may be exposed to “sniffing” and hacker attacks, and as the password or code gets into the hands of an intruder, the private key could be captured by others, and the corresponding identity could be abused.

In addition, documenting a conference would require more than a one-time authentication. The participants should ideally be authenticated continuously to keep track of the identity of all the participants at any time during the conference.

### SUMMARY OF THE INVENTION

The present invention relates to conferencing and data recording, in particular to providing secured and verified transactions by means of biometrics.

It is an object of the present invention to provide a method and a system that overcome the above-described problems.

The features defined in the independent claims enclosed characterize this system and method.

In particular, the present invention discloses a method for providing a secure and/or reliable digital action and/or verification, comprising the steps of capturing a first biometric pattern from a present individual, comparing said first biometric pattern with one or more pre-stored second biometric patterns, or a first code generated from said first biometric pattern with one or more pre-stored second codes generated from said one or more second biometric patterns, and, if a match is found, providing an identification of said individual by means of said first biometric pattern, or said first biometric code, and/or using said identification, said first biometric pattern, or said first biometric code for providing the secure and/or reliable digital actions and/or verification. The invention also includes a system corresponding to the above-described method.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is an illustration of encapsulation of an iris area detected within an image,

FIG. 2 is a graphical representation of two respective members of the family of the 2-D Gabor filters,

FIG. 3 shows the architecture of a first aspect of the present invention,

FIG. 4 shows the architecture of a second aspect of the present invention,

FIG. 5 shows the architecture of a third aspect of the present invention.

### DETAILED DESCRIPTION OF THE INVENTION

In the following, the present invention will be discussed by describing a preferred embodiment, and by referring to the accompanying drawings. However, people skilled in the art will realize other applications and modifications within the scope of the invention as defined in the enclosed independent claims.

According to a preferred embodiment of the present invention, the uniqueness of biometrics is combined with the robustness and reliability of PKI for use in conference applications.

The field of biometrics include all human patterns that are individually unique and recognizable. The most common patterns used for identification are fingerprints, face patterns and irises. The great asset of biometrics is that the unique patterns always are carried along and attached to the body, and they remain unchanged during a lifetime.

According to one aspect of the present invention, iris recognition is used to identify the participants in a videoconference. Iris recognition in itself combines computer vision, pattern recognition and statistics. The purpose is real-time, high confidence recognition of a person's identity by mathematical analysis of the random patterns that are visible within the iris of an eye from some distance. Because the iris of every human eye has a unique texture of high complexity, which proves to be essentially immutable over a person's life, it can serve as a kind of living passport or a living password that one need not remember but always carries along. Because the randomness of iris patterns has very high dimensionality, recognition decisions are made with confidence levels high enough to support rapid and reliable exhaustive searches through national-sized databases.

Most iris recognition systems are principally operated by means of algorithms and methods developed by John Daugman from the University of Cambridge, the principles of which are disclosed in Daugman, J. (1993) “High confidence visual recognition of persons by a test of statistical independence”, IEEE Transactions on Pattern Analysis and Machine Intelligence, vol. 15(11), pp. 1148-1161 and U.S. Pat. No. 5,291,560 issued Mar. 1, 1994 (J. Daugman).

The Daugman method starts by analyzing a captured image to detect edge boundaries. Edge boundary detection utilizes contour integration of circles of increasing radius to search for the maximum in the blurred partial derivative. This can be expressed as follows:

$${max}_{( r , {x}_{0} , {y}_{0} )} \vert {G}_{σ} ( r ) * \frac{\partial }{\partial r} {∮}_{r , {x}_{0} , {y}_{0}} \frac{I ( x , y )}{2 π r} ds \vert$$

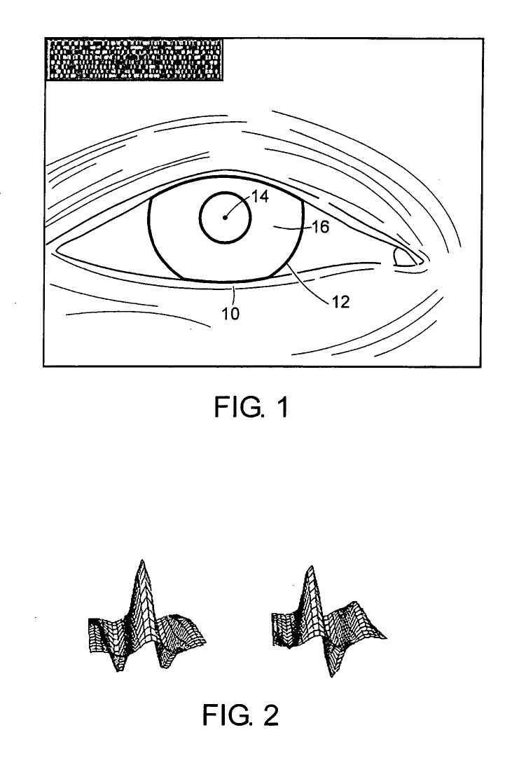

This detection serves to find both the pupillary boundary and the outer (limbus) boundary of an iris presented in the image. A similar approach to detecting curvilinear edges is used to localize both the upper and lower eyelid boundaries. Combining the detected boundaries 10, 12, 14 will encircle the area of interest 16 as shown in FIG. 1.

When the iris area is detected, the method proceeds by demodulating the pixel values therein. The iris pattern is demodulated to extract its phase information using quadrature 2D Gabor wavelets, the properties of which are particularly useful for texture analysis, because of the 2-D spectral specificity as well as positional dependency of texture. Two members of the family of 2-D Gabor filters are illustrated in FIG. 2, as even-symmetric and odd-symmetric wavelet profiles together with their contour plots. These localized, undulating 2-D functions, defined at many different sizes and positions, are multiplied by the raw image pixel data and integrated over their domain of support to generate coefficients which describe, extract, and encode image texture information.

The result is a phase quantization of each patch of the iris area, expressed as an imaginary number. The imaginary number is then digitized by being exposed to a sign function, i.e. the real and imaginary parts are either 1 or 0 (sgn) depending on the sign of the 2D integral. The result of the demodulation process is a phase code of normally 2048 bits, which are equally likely to be 1 or 0. The complete expression is shown below:
h_{{Re,Im}}=sgn_{{Re,Im}}∫_{ρ}∫_{φ}I(ρ,φ)e^{-iω(θ}^{₀}−φ)e^{-(r}^{ₒ}^{-ρ)}^{²}^{/α}^{²}e^{-(θ}^{ₒ}^{-φ}^{²}^{/β}^{²}ρdρdφ
The pattern in the upper left hand corner of the iris image of FIG. 1 is an illustration of an example of a phase code representing the iris image.

The generated phase code representing an iris may then be used to compare with a number of known pre-stored phase codes. The key to iris recognition is the failure of a test of statistical independence, which involves so many degrees-of-freedom that this test is virtually guaranteed to be passed whenever the phase codes for two different eyes are compared, but to be uniquely failed when any eye's phase code is compared with another version of itself. The test of statistical independence is implemented by calculating a so-called Hamming Distance (HD), which includes several simple Boolean operations. The expression for determining the Hamming Distance between a code A and a code B is shown below:

$$HD = \frac{‖ ( code A ⊗ code B ) ⋂ mask A ⋂ mask B ‖}{‖ mask A ⋂ mask B ‖}$$

The XOR operator detects disagreement between any corresponding pair of bits, while the AND-operator ensures that the compared bits are both deemed to have been uncorrupted by eyelashes, eyelids, specular reflections, or other noise. The denominator tallies the total number of phase bits that mattered in iris comparisons after artifacts such as eyelashes and specular reflections were discounted, so the resulting HD is a fractional measure of dissimilarity. A low HD distance will therefore imply a match. Statistically, with a HD criterion of 0.3, the probability for erroneously assuming a match will be 1 in 1.5 billion.

Using iris recognition for identifying individuals is well suited for video conferencing purposes as image capturing and processing means are already integrated in the equipment, and the eyes of the participant are normally always within the views that are being captured. In addition, meetings are often started by introducing the participants, but as the participants are localized at different sites, the identities may become uncertain and unreliable. A simple approach to overcome this problem would therefore be to provide the identities of the participants at one site by means of iris recognition, and present the identities to the remaining sites, as e.g. text on the video screen. This requires a pre-storage of the biometric patterns, or codes representing biometric patterns, of potential conference participants, e.g. in a local database managed from, or integrated in, a management tool connected to the conferencing system. Such management tools are common in large conferencing systems for managing i.a. the conference units like the end-points, MCU's and Gateways and the users registered thereto, in addition to scheduling future and present conference calls. A conference management tool would be perfectly suited to handle pre-capturing, storage and management of biometric patterns, and to providing the respective identities associated therewith.

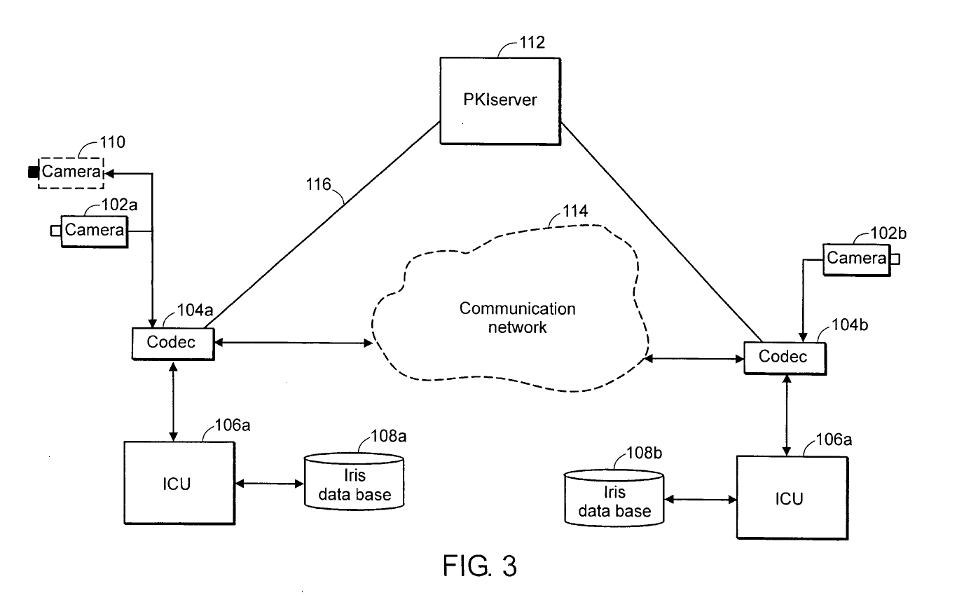

However, this would still fail to authenticate the participants, and the data cannot be signed or encrypted by means of a locally initiated identification only. This could be solved by combining the reliability of iris identification with the integrity and confidence of PKI. PKI has turned to be both reliable and relatively simple. In addition, PKI is widely used, and fulfills the requirements for legally binding. However, using a PIN code for each participant in a videoconference to fetch the respective Digital Certificates would be inconvenient and unnatural. In contrast, as End-Points in videoconference systems always include image-capturing means, iris recognition would be perfectly suited for replacing the PIN codes. FIG. 3 shows an overview of merging iris recognition with PKI infrastructure in a videoconference system. The system includes cameras 102a, 102b connected to codecs 104a, 104b. The codecs communicate across communication network 114.

The camera 102a, 102b provides an image to an ICU (Iris Control Unit) 106a, 106b via the codec 104a, 104b. The ICU extracts any irises included in the image and generates iris codes for the respective detected irises. The iris codes are compared with the iris codes in the iris database 108a, 108b, and in case of a match, the corresponding identification is provided to the ICU. The identification may include an identification code that preferably corresponds directly to a DC in PKI server 112. The identification code is transmitted to the PKI server via the codec over a secure connection 116, and the DC associated with which, possibly in addition to the corresponding private key, is captured from the PKIserver and transmitted back to the codec. When the codec is in possession of the DC's of the participants, they can be used to execute secured and verified transactions.

The most obvious action is to authenticate the participants at the near-end side for the participants at the far-end side. This could be done in that the codec at the near-end side simply transmits the DC's of the participants to the codec at the far-end side. The codec of the far-end side decrypts the DC's by the public key of the certificate issuer provided by the PKIserver. The identification information included in the certificates may then be used to present the identity of the participants at the near-end side for the participants at the far-end side, or it may be stored together with a record of the meeting as a presence proof. The identities would then be verified by a trusted third party system, as opposed to merely rely on the local identification process at the near-end side. In addition, the conventional use of PIN code/password is replaced with a much more reliable “non-touch” biometric system. In addition to present verified identities to the far-end side, the authentication would also be useful in accessing users to end-points and other conference units at various security levels. A traditional log-in procedure require a user name and password, but this could advantageously be replaced by iris recognition.

The certificates and private keys may also be used for plain encryption of the conference, but even more interesting, it may be used to sign the data that is being transferred between the end-points in the conference. When the multimedia data is encrypted by the private key of one or more of the conference participants at the near-end side, the far-end side can rely on that the persons at the near-end side are the ones they claim to be, and that the received data is the same as the near-end side transmitted if the data is decryptable by the corresponding public key(s) included in the certificates. This corresponds to the way data is being signed in other contexts, but the difference is that by means of iris recognition, the participants' presence and look into the camera will “sign” the video conferencing data that is being transferred. This feature will make video conferencing even more reliable, and applicable.

One situation where signing of videoconference data could be useful is in a contracting situation. Records of signed meetings wherein verbal agreements or mutual comprehensions are established will be a strong proof and juridical documentation. Of course, the juridical aspect would be useful also in other situations, where non-deniable identification or content signing are required. As an example, providing a record of an interrogation by using the present invention, would be a convincing proof of a confession or a testimony. Another example of use would be in exam situations to make sure that the candidate is the one he/she claims to be, not only at the time of attendance and hand-ins, but during the whole examination.

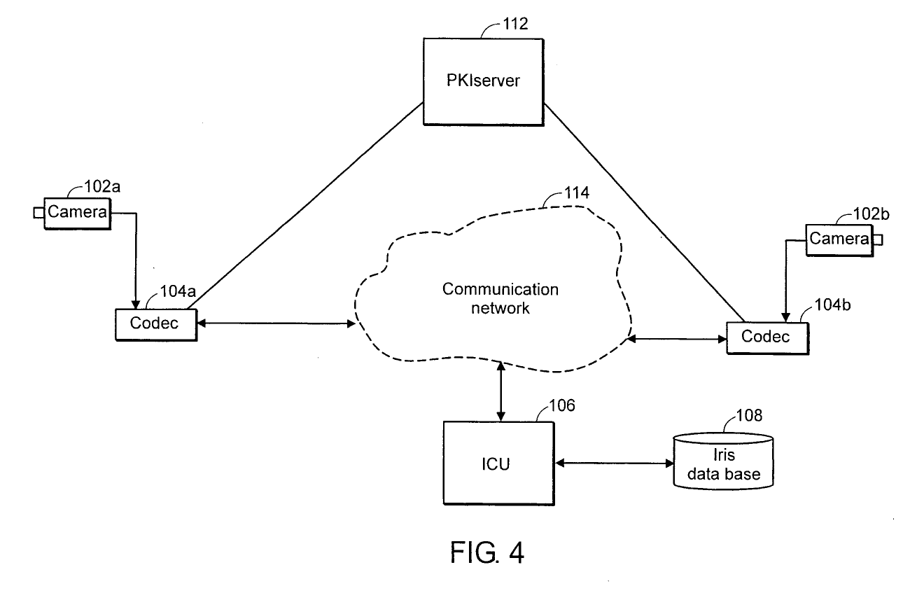

However, the present invention is not limited to the architecture shown in FIG. 3. As an example, the ICU and iris database could also be centralized units 106, 108, respectively, independently connected to the communication network being available for more than one or a limited number of videoconferencing end-points, as indicated in FIG. 4. The iris database could be a database storing irises of employees in a company, or alternatively a national iris register. In the case of a national register, the ICU would preferably be separated from the database, as the operations of the ICU typically would be connected to the camera(s) it is serving.

An alternative to the iris database would be to compare the irises captured by the cameras with corresponding individual irises stored on e.g. personal SmartCards, electronic passports, etc. This would require reading devices connected to the end-points for capturing the iris code of the respective participants.

In the description of the present invention, the codec shown in FIG. 3 and 4 has so far been used merely as a information exchanger and transmitter. However, in videoconferencing, one of the main tasks of the codec is to code and compress the raw video data provided by the conference camera. When preprocessing the data, a lot of information concerning the content of the captured images to be used in the coding and compressing are revealed. This information may be related to movements, texture, chrominance and luminance at different locations in the image. According to one embodiment of the invention, this information is used as a supplement in detecting iris areas in the captured images. To reduce the area of iris searching within the images, and thereby saving processing time, certain areas may be excluded from the iris search if they include one or more characteristics making it unlikely that iris areas would be localized therein. Examples of such characteristics could be movements, certain chrominance or luminance values or absence of texture.

A problem that may occur when utilizing a video conference camera as the iris capturing means, is that the captured iris areas could happened to be to small, so that the ICU is not able to generate the proper code representing the iris patterns. This may occur when the participants are placed too far from the camera, or if the conferencing camera is not capable of capturing images of sufficient resolution. One solution to this problem is indicated in FIG. 3. As can be seen, above the main conference camera 102a, there is added a supplementary camera 110, whose purpose is merely to capture iris areas. Either the main camera or the supplementary camera itself, initially captures a general view of the conference where the end-point is localized. The ICU processes this general view to detect if any iris areas are included. The detection may be carried out in the conventional way as described earlier, or a simpler approach adjusted to iris areas of low resolution may be used. The simplified detection could include aspects of face recognition and knowledge of general eye distance and position within the face, or characteristics provided from the compression pre-processing in the codec. As a preliminary detection of the iris areas is provided, the supplementary camera would be able to consecutively zoom onto, and capture a high-resolution image of, the respective eyes of the participants included in the general view. The respective high-resolution images could then undergo conventional iris recognition as described earlier. Note that when the general view is captured by the main camera, relational data between that camera and the supplementary camera, like distance, resolution ratio etc., must be pre-stored for the supplementary camera to zoom correctly. Further, it would also be possible to integrate the supplementary camera in the main camera e.g. as a high-resolution snapshot camera sharing its camera lens with the main camera.

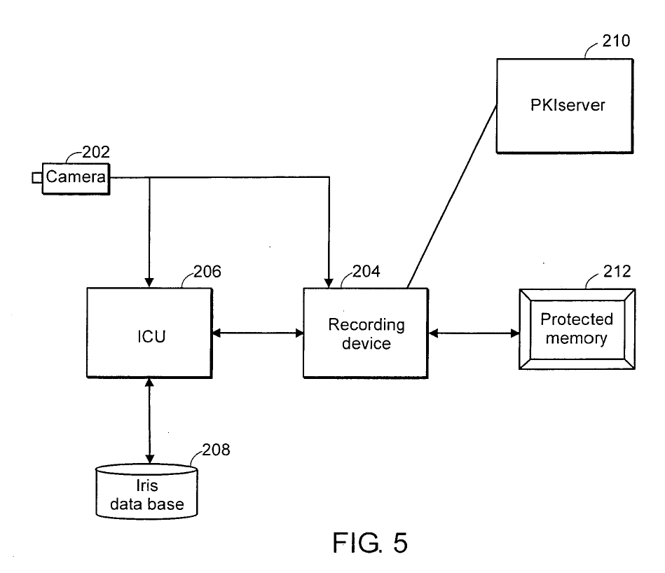

The present invention does not necessarily apply to video conferencing only. It would also be useful for recording a meeting wherein a verbal agreement is settled and all the participants resides at the same location. The architecture of which may be embodied as shown in FIG. 5. The system includes camera 202 connected to recording device 204 and ICU 206. As no multimedia communication is required, the codec is omitted. Instead, recording device 204 and protected memory device 212 are installed for the purpose of securely storing a record of the meeting, which preferably is signed with the contracting parties' respective private key using iris database 208 and PKI server 210.

As indicated in the preamble, the present invention is not limited to iris recognition only. In fact, all individual recognition provided by means of all kinds of biometrics may be applicable. The most obvious would be to use human fingerprint instead of iris as the identification means. This would also require storage of patterns in a database or in a personal memory device for comparison with captured fingerprints. In addition, a fingerprint scanner would have to be coupled to the end-points as a supplementary to the conferencing equipment. Another alternative biometric pattern would be the face appearance. However, this would require greater processor resources, and are probably less reliable than both iris and fingerprint recognition.

Further, the present invention is not restricted to transceiving/recording moving pictures. It is also applicable in connection with audio and data conferences or solely recording of audio or data.

While this invention has been particularly shown and described with references to preferred embodiments thereof, it will be understood by those skilled in the art that various changes in form and details may be made therein without departing from the scope of the invention encompassed by the appended claims.

1. A method for providing a secure and/or reliable digital action and/or verification in connection with a conference call, comprising:
capturing a first biometric pattern from a present individual;
comparing said first biometric pattern with one or more pre-stored second biometric patterns, or a first code generated from said first biometric pattern with one or more pre-stored second codes generated from said one or more second biometric patterns, and, if a match is found,
providing an identification of said individual using said first biometric pattern, or said first biometric code, and/or
using said identification, said first biometric pattern, or said first biometric code for providing the secure and/or reliable digital actions and/or verification in the conference call.

2. A method according to claim 1,
characterized in that the secure and/or reliable digital action and/or verification is provided by Private Key Infrastructure (PKI).

3. A method according to claim 1,
characterized in that the secure and/or reliable digital action and/or verification include identification, authentication, signing and/or encryption/decryption, utilizing a private/public key pair and a Digital Certificate (DC) associated with said individual, issued by a trusted authority, and that said identification allows capturing said private/public key pair and said Digital Certificate (DC).

4. A method according to claim 1,
characterized in that said first biometric pattern is an iris pattern.

5. A method according to claim 4,
characterized in that capturing further includes:
capturing an image of said individual by an image capturing means;
detecting and encapsulating one or both iris area(s) of said individual within said image;
generating said first code from pixel values of said iris area or one of said both iris areas.

6. A method according to claim 1,
characterized in that said first biometric pattern is a fingerprint.

7. A method according to claim 1,
characterized in that said first biometric pattern is a face appearance.

8. A method according to claim 1,
characterized in that the secure and/or reliable digital action and/or verification is a log-in action providing access to said conference call and/or an end-point, a security level and/or a session associated with said conference call.

9. A method according to claim 1,
characterized in that the conference call is a video conference call and capturing includes capturing an image of said individual by a video conference camera connected to said end-point.

10. A method according to claim 1,
characterized in that the conference call is a video conference call and capturing said iris pattern further includes zooming, with a high-resolution camera either combined with or separated from an associated video conference camera, onto said iris pattern by means of a detection of said iris pattern in a general view captured by said video conference camera or said high-resolution camera itself.

11. A method according to claim 9, characterized in that capturing a first biometric pattern further includes detecting iris areas by means of image characteristics provided by a compression and/or coding pre-process in a codec associated with said end-point.

12. A method according to claim 1,
characterized in that using said identification, said first biometric pattern, or said first biometric code, further includes:
recording audio and/or video data associated with said individual and/or surroundings of said individual;
signing and/or encrypting said recorded data;
storing said signed/encrypted recorded data in a secure memory device.

13. A system adjusted to provide a secure and/or reliable digital action and/or verification in connection with a conference call, the system comprising:
a capturing means adjusted to capture biometric patterns;
a database adjusted to pre-store a number of biometric patterns or a number of codes representing said number of biometric patterns;
an Identification Control Unit (ICU) adjusted to:
compare a biometric pattern from a present individual captured by said capturing means with said number of biometric patterns, or a code representing said biometric pattern with said number of codes stored in said databases; and to provide an identification associated with said biometric pattern if a match is found;
wherein the system provides the secure and/or reliable digital action and/or verification by means of said identification.

14. A system according to claim 13,
characterized in that a Private Key Infrastructure (PKI) provides the secure and/or reliable digital action and/or verification.

15. A system according to claim 13,
characterized in that the secure and/or reliable digital action and/or verification include identification, authentication, signing and/or encryption/decryption, utilizing a private/public key pair and a Digital Certificate (DC) associated with said individual, issued by a trusted authority, and that said identification allows capturing said private/public key pair and said Digital Certificate (DC).

16. A system according to claim 13,
characterized in that said first biometric pattern is an iris pattern.

17. A system according to claim 16,
characterized in that the capturing means is an image capturing means adjusted to capture an image of said individual, and that the ICU is further adjusted to:
detect and encapsulate one or both iris area(s) of said individual within said image, and generate said first code from pixel values of said iris area or one of said both iris areas.

18. A system according to claim 13,
characterized in that said first biometric pattern is a fingerprint.

19. A system according to claim 13,
characterized in that said first biometric pattern is a face appearance.

20. A system according to claim 13,
characterized in that the secure and/or reliable digital action and/or verification is a log-in action providing access to said conference call and/or an end-point, a security level and/or a session associated with said conference call.

21. A system according to claim 13,
characterized in that the conference call is a video conference call and said capturing means is a video conference camera connected to said end-point.

22. A system according to claim 13,
characterized in that said first biometric pattern is an iris pattern, and further that
a high-resolution camera, either combined with or separated from an associated video conference camera, adjusted to zoom onto said iris pattern by means of a detection of said iris pattern in a general view captured by said video conference camera or said high-resolution camera itself.

23. A method according to claim 22,
characterized in that said capturing means is further adapted to detect iris areas by means of image characteristics provided by a compression and/or coding pre-process in a codec associated with said end-point.

24. A system according to claim 13, further comprising:
a recording device adjusted to record audio and/or video data associated with said individual and/or surroundings of said individual; and
a secure memory device adjusted to store said recorded data being subjected to the secure and/or reliable digital action and/or verification.
